(19) United States
(12) Patent Application Publication
(10) Pub. No.: US 2008/0047235 A1
(43) Pub. Date: Feb. 28, 2008

(54) PACKAGE OPENING BLADE AND METHOD

(75) Inventor: Michael D. Greenberg, Bloomfield, CT (US)

Correspondence Address: BACHMAN & LAPOINTE, P.C. (P&W), 900 CHAPEL STREET, SUITE 1201, NEW HAVEN, CT, 06510-2802, US

(73) Assignee: UNITED TECHNOLOGIES CORPORATION, Hartford, CT (US)

(21) Appl. No.: 11/931,917

(22) Filed: Oct. 31, 2007

Related U.S. Application Data
(62) Division of application No. 11/499,089, filed on Aug. 4, 2006.
(63) Continuation-in-part of application No. 11/499,089, filed on Aug. 4, 2006.

(51) Int. Cl. B67B 7/00; B65B 43/26; B65B 69/00

(52) U.S. Cl. 53/492

(57) ABSTRACT

A knife has a handle. A blade extends from the handle and has opposite first and second sides. The blade has a notch. A first region extends along a proximal portion of the notch and has a double grind. A second region extends along a distal portion of the notch and has a double grind. The knife has a point.

### CROSS-REFERENCE TO RELATED APPLICATION

This is a divisional and continuation in part of U.S. patent application Ser. No. 11/499,089, filed Aug. 4, 2006, and entitled “Package Opening Blade and Method”, the disclosure of which is incorporated by reference in its entirety herein as if set forth at length.

### BACKGROUND OF THE INVENTION

The invention relates to thermoformed plastic packaging. More particularly, the invention relates to tools for opening thermoformed plastic packaging.

Thermoformed plastic packaging (typically known as clamshell packaging) has become ubiquitous. Polyethylene and polyethylene terephthalate are exemplary package materials. A typical package involves a clear plastic piece with a live hinge. In a folded configuration, the portions of the plastic on opposite sides of the hinge form two layers. Exemplary layer thickness is 0.13-0.76 mm (0.005-0.030 inch), more typically 0.18-0.48 mm (0.007-0.019 inch). One or both of these layers contains a thermoformed blister defining a compartment for receiving the products. Although reclosable configurations (e.g., with integrally-formed snap features) are known, product security favors a welded construction. In an exemplary welded construction, a perimeter portion of the two layer sandwich is thermally welded requiring substantial destruction of the package to access the enclosed product.

Opening of the packaging is difficult. A user may typically attempt to open the package using whatever sharp object is at hand, often with difficulty or injury. The presence of a structural channel adjacent the seam and the presence of internal cardage, documentation, and the like, make cutting with scissors difficult. Various dedicated opener devices have been proposed. US Patent Application Publication 20050229397, the disclosure of which is incorporated by reference herein as if set forth at length, discloses one attempt.

### SUMMARY OF THE INVENTION

One aspect of the invention involves a knife having a handle. A blade extends from the handle and has opposite first and second sides. The blade has a notch. A first region extends along a proximal portion of the notch and has a double grind. A second region extends along a distal portion of the notch and has a double grind. The knife has a point.

The point is located at a distal end of the second region. The point is positioned to penetrate at least the first layer of a two-layer clamshell package. The notch is positioned so that a pulling of the blade after the penetrating through cuts at least the first layer.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a knife having an extended package opening blade.

FIG. 2 is a side view of the knife of FIG. 1.

FIG. 3 is an enlarged side view of a distal region of the blade of FIG. 1.

FIG. 4 is an edge view of the blade of FIG. 1.

FIG. 5 is a partially schematic side view of the blade of FIG. 1 in a first stage of package opening.

FIG. 6 is a view of a second stage of package opening.

FIG. 7 is a view of a third stage of package opening.

Like reference numbers and designations in the various drawings indicate like elements.

### DETAILED DESCRIPTION

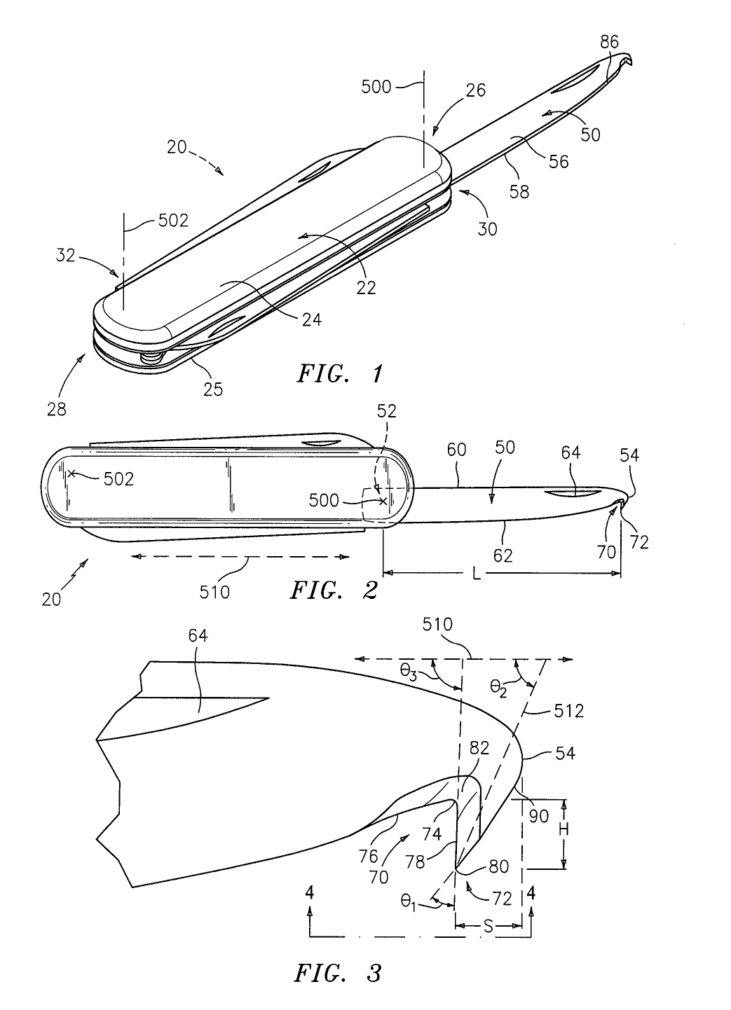

FIGS. 1 and 2 show a knife 20. The exemplary knife is a pocket-style knife having a body/handle 22 including a pair of side plate assemblies 24 and 25. The handle has first and second ends 26 and 28. First and second pluralities of blades 30 and 32 are respectively hinged at axes 500 and 502 near the first and second ends. The various blades have deployed/extended/opened conditions wherein their functional edges are clear of the handle and stowed/closed conditions wherein at least portions of the functional edges are stowed within the handle. Typically, spine portions of the blades may be exposed in the stowed condition to permit grasping to open the blades.

The aforementioned construction is merely exemplary of certain prior art knife configurations in which the inventive blades may be incorporated. Yet other knife constructions are possible.

FIGS. 1 and 2 further show the first plurality 30 of blades as including a package-opening blade 50 shown in a deployed/extended/opened condition. The blade 50 has a proximal end 52 within the handle at the hinge axis 500. The blade has a distal end 54 or tip. The knife has a first face 56 and an opposite second face 58. The faces 56 and 58 are generally parallel and spaced apart to define a blade thickness. The blade has a spine edge 60 and an opposite functional edge 62. In at least one of the faces 56 and 58, a thumbnail opening groove 64 may be located near the spine edge 60. In the closed/stowed condition, the thumbnail groove may be slightly exposed from the handle permitting the user to grasp the blade to open it. A portion of the blade near the edge 62 may be stowed between the side plates in the closed condition. FIG. 2 also shows a longitudinal direction 510 of the handle and extended blade.

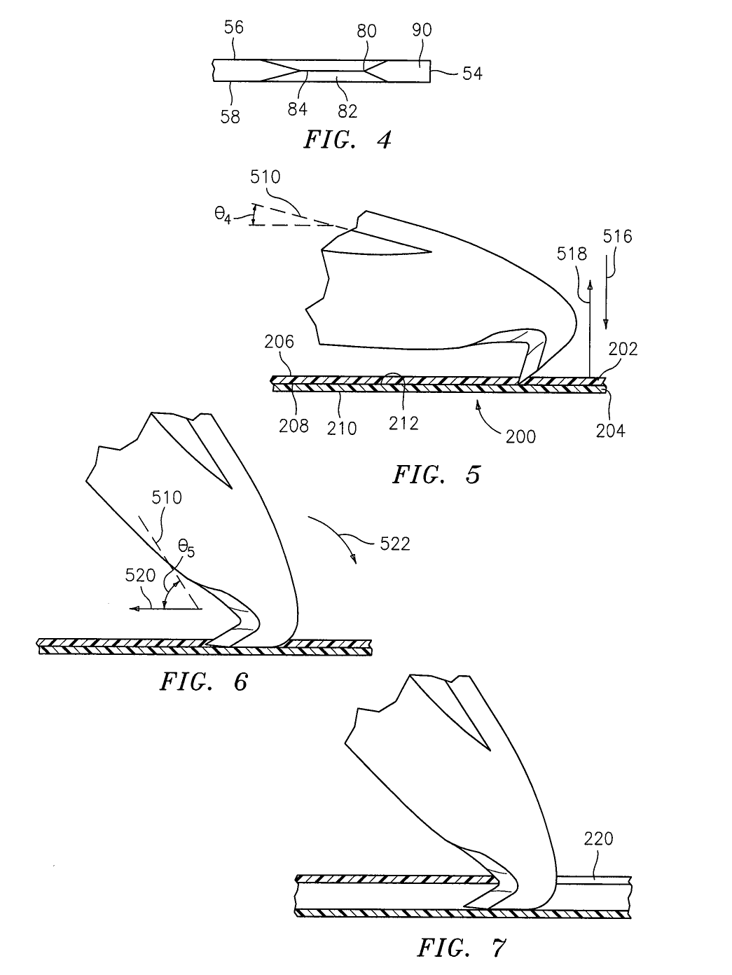

As is discussed in further detail, along the edge 62, the exemplary blade has a distal notch 70 with a point 72 at a distal end of the notch. An exemplary length L from the axis 52 to the point 72 is 30-60 mm, more narrowly 40-50 mm. FIG. 3 shows the notch having an end or vertex 74. A first region 76 is along a proximal portion of the notch (i.e., proximally of the vertex 74). A second region 78 is along a distal portion of the notch (e.g., between the vertex 74 and the apex 80 of the point 72). A double grind 82 (i.e., ground from both blade faces 56 and 58) is along both the portions 76 and 80. The exemplary double grind forms a sharp edge 84 (FIG. 4) along the portion 78 and a distal subportion of the portion 76. A surface 90 extends along the point from the apex 80 to the blade distal end/tip 54.

FIG. 3 further shows a centerline 512 of the point 72. The point 72 is shown with a longitudinal terminal angle θ₁ between the notch second region 78 and the surface 90. The centerline 512 is at an angle θ₂ relative to the longitudinal direction 510. The notch second region 78 is at an angle θ₃ relative to the longitudinal direction 510. Exemplary θ₁ are 30-50°, more narrowly 35-45°. Exemplary θ₂ are 50-80°, more narrowly 55-70°. Exemplary θ₃ are 70-100°, more narrowly 75-85°. FIG. 3 further shows an exemplary notch height H normal to the longitudinal direction 510. Exemplary H is 1.0-3.0 mm, more narrowly 1.3-1.6 mm. FIG. 3 further shows a longitudinal span S of the of the tip beyond the vertex 74 and notch second region 78. Exemplary S is 1.0-3.0 mm, more narrowly 1.2-2.5 mm, and yet more narrowly 1.3-1.8 mm.

FIG. 5 shows a package 200 having a first layer 202 and a second layer 204. The first layer has an outer surface 206 and an inner surface 208. The second layer 204 has an outer surface 210 and an inner surface 212. In an initial stage of opening, the point 72 is penetrated in a direction 516 nearly anti-parallel to the surface normal 518 from the outer surface 206 at least partially through the first layer 202. During this stage, the longitudinal direction 510 is shown off-parallel to the surface 206 by an angle θ₄. Advantageous θ₄ are sufficiently high to permit the combination of a user's fingers between the handle and the package during this insertion stage (e.g., a finger thickness of about 1.5 cm at the handle end 30).

In one exemplary method, the tip does not penetrate (or at least fully penetrate) the second layer 204. The tip may be drawn in a direction 520 and rotated in a direction 522. The rotation may be to an orientation such as shown in FIGS. 6 and 7 and then essentially stopped. An angle θ₅ between the longitudinal direction 510 and the surface/translation direction 520 is an exemplary 20-60°, more narrowly 35-50°.

The drawing/translation may continue. For example, FIG. 7 shows an essentially steady-state drawing in the direction 520. The relative angle between the region 78 and the direction 520 may draw the first layer away from the second layer to separate the two layers. The surface 90 may drive along the inboard surface 212 of the second layer to prevent cutting of the second layer. The drawing of the knife leaves a cut 220 in its wake in the first layer.

During cutting, the blade may be rolled (i.e., rotated slightly around a longitudinal axis) so that the plane of the blade is not locally orthogonal to the package material. This may improve user comfort and may improve retention of the first layer by the blade.

In alternative methods, the tip may penetrate both layers to cut both layers. In further alternative methods, there may be an intervening layer (e.g., a manual or cardage along which the surface 90 rides so as to avoid damage thereto). In yet other alternative methods, the cut may be made in a location where the two layers are not directly or indirectly (via cardage) contacting. For example, the cut may be made along the blister, near the periphery of the blister (e.g., to partially (e.g., leaving a hinge) or fully remove the blister). At such a cut, the cut layer may be extending out of and transverse to the mating plane and the blade may only engage the cut layer (e.g., without engaging the other layer to separate the two).

Other used involve cutting the electrical wire or cable jacket (e.g., of NM-B (non-metallic, variant B) cable). Other uses involve cutting plastic wrapper from optical disk packaging (e.g., CD or DVD). Other uses involve cutting tape (e.g., fiber-reinforced paper tape) on boxes/cartons wherein the double grind along the notch captures and cuts the tape/fibers with minimal risk of penetration to the contents.

Blades having notch-like structures are known for other purposes. Various Swiss Army brand knives by Victorinox SA feature an orange peeler blade (sometimes identified as a “cut and picker”). The peeler blade has a notch. A point at a distal end of the notch is positioned to dig into and penetrate the peel. The point is not configured to readily penetrate a clamshell package. For example, the point is oriented relatively close to longitudinal with the surface distal of the point being essentially longitudinal. Such a point orientation would make it difficult to penetrate the clamshell package. Softness, texture, and curvature allow the point to penetrate the peel. Also, the notches are singly ground. A single grind will tend to steer the blade, making it difficult to guide the cut.

The illustrated example is in the context of a consumer pocket knife (e.g., a Swiss Army-style knife). Other configurations are possible. For example, for commercial use, a larger or more robust blade and/or a replaceable blade may be advantageous. For example, a replaceable blade may be configured for utility knife use.

One or more embodiments of the present invention have been described. Nevertheless, it will be understood that various modifications may be made without departing from the spirit and scope of the invention. For example, when implemented as a modification of an existing knife, details of the existing knife may influence details of any particular implementation. Also, it may be possible to combine, in a single blade, features of the package opener along with features for other purposes. Accordingly, other embodiments are within the scope of the following claims.

What is claimed is:

1. A method for opening a package having first and second plastic layers, the method comprising:
penetrating a point of a blade into the first layer; and
pulling the blade so that a notch region of the blade through-cuts the first layer.

2. The method of claim 1 further comprising:
after the penetrating, rotating the blade so that a camming surface of the blade engages the second layer and separates the first layer from the second layer.

3. The method of claim 1 wherein:
the pulling guides the first layer at a leading edge of the through-cut into a vertex region of the notch.

4. The method of claim 1 wherein:
the through-cut is made around a periphery of a blister.

5. The method of claim 1 wherein:
the through-cut is made around a perimeter of the package.

6. The method of claim 1 performed with a knife comprising:
a handle; and
said blade extending from the handle and having:
a first side;
a second side opposite the first side;
said notch;
a first region along a proximal portion of the notch and having a double ground edge;
a second region along a distal portion of the notch and having a double ground edge; and
said point.

7. The method of claim 6 wherein:
the point is at a distal end of the second region.

8. The method of claim 6 wherein:
the blade is a folding blade; and
the knife has a plurality of other blades.

9. The method of claim 8 wherein:
a base of the notch is 30-60 mm from a pivot axis of the blade.

10. The method of claim 8 wherein:
the blade has a smooth lead in to the notch at least 20 mm long.

11. The method of claim 6 wherein:
the notch has a centerline angled back toward the handle.

12. The method of claim 6 wherein:
the point has a centerline angled back toward the handle and within 45° of normal to a longitudinal direction of the handle.

13. The method of claim 6 wherein:
a majority of the second region is 75-100° off longitudinal.

14. The method of claim 6 wherein:
the notch has a height of 1.0-3.0-6 mm.

15. The method of claim 6 wherein:
the blade has a thumb groove.
